(19) United States
(12) Patent Application Publication
(10) Pub. No.: US 2021/0237223 A1
(43) Pub. Date: Aug. 5, 2021

(54) A POWER TOOL

(71) Applicant: TECHTRONIC CORDLESS GP, Anderson, SC (US)

(72) Inventors: Kwok Ting MOK, Hong Kong (CN); Zhi Qiang YE, Dongguan (CN)

(21) Appl. No.: 17/262,853

(22) PCT Filed: Jul. 30, 2018
(86) PCT No.: PCT/CN2018/097741

§ 371 Date: Jan. 25, 2021

(51) Int. Cl. B24B 23/06; H02K 7/14; H02K 7/00

(52) U.S. Cl. CPC B24B 23/06; H02K 7/003; H02K 7/145

(57) ABSTRACT

A power tool includes a generally elongate tool housing defining a longitudinal axis parallel with the length of the tool housing, a work tip located at a first end of the tool housing for supporting a work member, and a power source interface located at a second end of the tool housing for supporting a removable power source. The tool housing includes an elongate handle-shaped grip region between the work tip and power source interface, and generally parallel to the longitudinal axis, and a drive region that substantially encloses a motor separately from the handle-shaped grip region. The motor is located between the handle-shaped grip region and the work tip.

### FIELD OF INVENTION

The present invention relates to power tools and a housing for use in power tools. Particularly, but not exclusively, the present invention relates to a power file.

### BACKGROUND OF INVENTION

Tasks typically performed by a power tool, such as filing or sanding, generally require steady control of the power tool by a user. This user control is provided by a gripping region in the housing which is gripped by the user. However, the gripping region is often large and difficult to grip as it may enclose components of the power tool, leading to low user comfort and control. Power tools that provide improved user handling and comfort are desired.

### SUMMARY OF INVENTION

In light of the foregoing background, it is an object of the present invention to provide a power tool which addresses the above technical problems.

In a first aspect of the present invention, there is provided a power tool comprising a generally elongate tool housing defining a longitudinal axis parallel with the length of the tool housing, a work tip located at a first end of the tool housing for supporting a work member, and a power source interface located at a second end of the tool housing for supporting a removable power source. The tool housing comprises an elongate handle-shaped grip region between the work tip and power source interface, and generally parallel to the longitudinal axis, and a drive region that substantially encloses a motor separately from the handle-shaped grip region, and wherein the motor is located between the handle-shaped grip region and the work tip.

In an embodiment of the first aspect, the motor has a motor shaft oriented generally perpendicular to the longitudinal axis.

In an embodiment of the first aspect, the drive region further encloses a transmission coupling an output of the motor shaft to the work tip.

In an embodiment of the first aspect, the drive region has a first girth configured to accommodate the motor, and wherein the handle-shaped grip region has a second girth that is smaller than the first girth.

In an embodiment of the first aspect, the elongate handle-shaped grip region is generally aligned along the longitudinal axis.

In an embodiment of the first aspect, the elongate handle-shaped grip region has a profile that conforms to an ergonomic grip profile of a user's hand.

In an embodiment of the first aspect, the power tool further includes a trigger configured to activate the motor, the trigger located at an end of the elongate handle-shaped grip region and adjacent to the drive region.

In an embodiment of the first aspect, the power source interface has battery engagement features for selectively engaging with a power tool battery along an engagement direction, wherein the engagement direction is perpendicular to the longitudinal axis.

In an embodiment of the first aspect, the power source interface has battery engagement features for selectively engaging with a power tool battery along an engagement direction, wherein the engagement direction is parallel to the longitudinal axis.

In an embodiment of the first aspect, the power tool is a power file having an elongate finger-shaped sanding member arranged generally parallel to the longitudinal axis.

In a second aspect of the present invention, there is provided a housing for a power tool comprising an elongate drive region defining a longitudinal axis, the drive region having a first girth configured to substantially enclose a tool motor and transmission; and an elongate handle-shaped grip region generally coupled with the drive region and parallel to the longitudinal axis, the grip region having a second girth configured to conform to an ergonomic grip profile of a user's hand, wherein the second girth is smaller than the first girth.

In an embodiment of the second aspect, the elongate drive region has a work tool interface at a first housing end opposite an end coupled with the grip region, and wherein the grip region has a power source interface located at a second housing end opposite an end coupled with the drive region.

In an embodiment of the second aspect, the tool motor has a motor shaft oriented generally perpendicular to the longitudinal axis.

In an embodiment of the second aspect, the housing further includes a trigger configured to activate the tool motor, the trigger located at an end of the grip region and adjacent to the drive region.

In an embodiment of the second aspect, the power source interface has battery engagement features for selectively engaging with a power tool battery along an engagement direction, wherein the engagement direction is perpendicular to the longitudinal axis.

In an embodiment of the second aspect, the power tool is a power file having an elongate finger-shaped sanding member arranged generally parallel to the longitudinal axis.

In a third aspect of the present invention, there is provided a power tool comprising a generally elongate tool housing defining a longitudinal axis parallel with the length of the tool housing, a work tip located at a first end of the tool housing for supporting a work member, and a power source interface located at a second end of the tool housing for supporting a removable power source. The tool housing comprises an elongate handle-shaped grip region between the work tip and power source interface, and generally parallel to the longitudinal axis, and a drive region that substantially encloses a motor separately from the handle-shaped grip region, and wherein the motor is located between the handle-shaped grip region and the work tip, wherein the motor is located at a position on the tool housing to provide a front-to-rear power tool center-of-gravity located at least partially proximate a front end of the elongate handle-shaped grip region.

In an embodiment of the third aspect, the front-to-rear power tool center-of-gravity increases a downward force on the work tip.

In an embodiment of the third aspect, the power source interface is located proximate a rear end of the elongate handle-shaped grip region.

In an embodiment of the third aspect, the motor has a motor shaft oriented generally perpendicular to the longitudinal axis.

In an embodiment of the third aspect, the elongate handle-shaped grip region is generally aligned along the longitudinal axis.

In an embodiment of the first aspect, the power tool is a power-file having an elongate finger-shaped sanding member arranged generally parallel to the longitudinal axis.

### BRIEF DESCRIPTION OF FIGURES

The foregoing and further features of the present invention will be apparent from the following description of preferred embodiments which are provided by way of example only in connection with the accompanying figures, of which:

FIG. 1 is a side perspective view of a power tool in a prior art.

FIG. 2 is a side perspective view of a power tool in accordance with a first example embodiment of the present invention.

FIG. 3 is a side view of the power tool in FIG. 1.

FIG. 4 is a side view of a power tool in accordance with an alternative example embodiment of the present invention.

FIG. 5 is a side view of the power tool in FIG. 1.

FIG. 6 shows components of a power tool in accordance with an example embodiment.

### DETAILED DESCRIPTION OF THE PREFERRED EMBODIMENTS

The following description is given by way of example only to illustrate preferred embodiments of the invention. In particular, the language and terminology used herein is for descriptive purposes only and is not intended to limit the scope or functionality of the invention. The invention may be employed in various combinations or embodiments utilizing various elements and means not explicitly described herein, but within the knowledge and skill of one skilled in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Terms such as “horizontal”, “vertical”, “upwards”, “downwards”, “above”, “below” and similar terms as used herein are for the purpose of describing the invention in its normal in-use orientation and are not intended to limit the invention to any particular orientation.

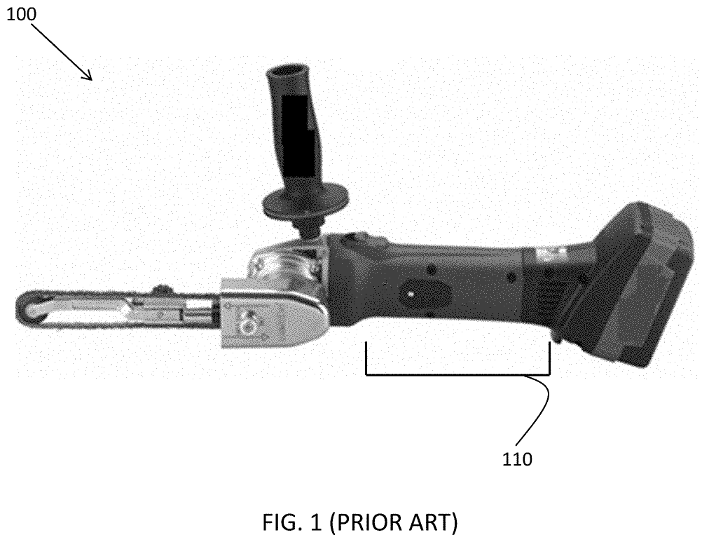

Power tools in the prior art are commonly found with larger handles that make the handling of the power tool more cumbersome. This is illustrated by FIG. 1 which shows a power tool 100 in the prior art. The grip region 110 in the power tool 100 is large and bulky as the grip region or handle 110 of power tools typically available in the prior art house the motor in order to make the power tools shorter. However, housing the motor in the grip region 110 consequently makes maneuverability of the power tool 100 difficult for the user as the grip region 110 cannot be easily or conveniently grasped. Further, the handle 110 cannot be ergonomically profiled as the handle is constrained to a larger girth due to enclosure of the motor. A slimmer, ergonomic handle or grip region would improve safe handling of the power tool and provide more user comfort during longer periods of use.

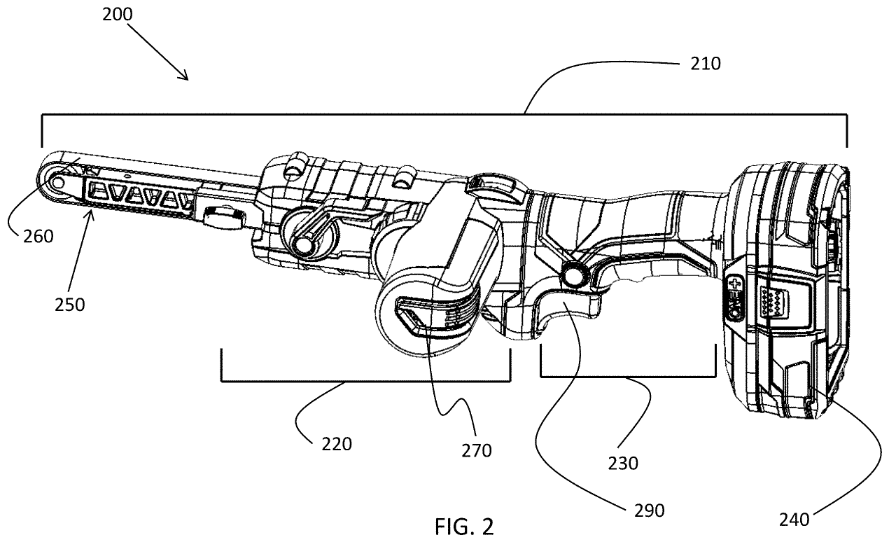

With reference to FIGS. 2 to 5, example embodiments provide a power tool that includes a generally elongate tool housing defining a longitudinal axis parallel with the length of the elongate tool housing, a work tip located at a first end of the tool housing, and a power source interface located at a second end of the tool housing. The tool housing includes an elongate handle-shaped grip region and a drive region. The drive region encloses a motor separately from the handle-shaped grip region, thereby allowing for a slimmer handle that can be ergonomically profiled.

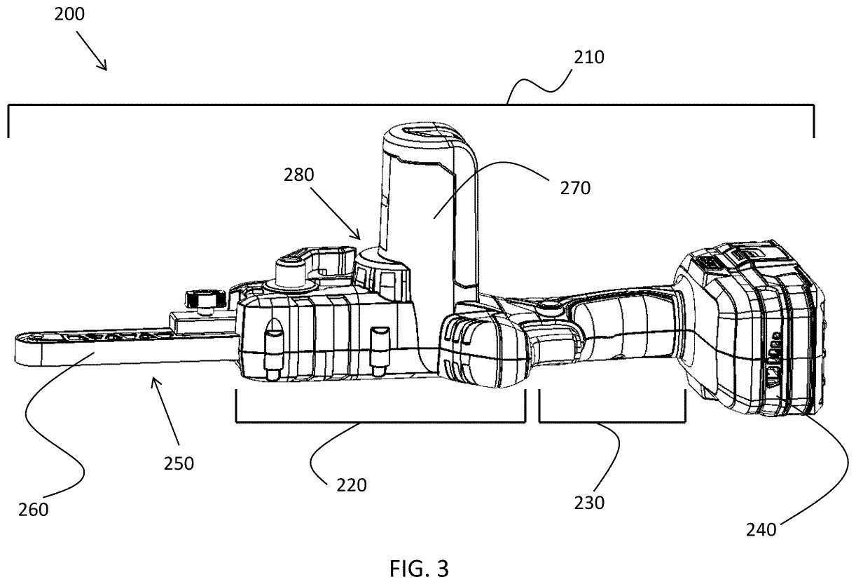

Referring initially to FIGS. 2 and 3, the first example embodiment is a power tool 200 e.g. a power file 200, with an elongate tool housing 210, a work tip 250 and a power source interface 240. The tool housing 210 defines a longitudinal axis that is parallel with the length of the elongate tool housing 210. The work tip 250 is located at a first end of the tool housing 210, or a first housing end, and supports a work member 260. As illustrated in FIGS. 2 and 3, the work tip 250 can be located at the forward end of the tool housing 210. The work member 260 may, for example, be a filer or a sander. The power source interface 240 is located at a second end of the tool housing 210, for example near the rearward or distal end of the tool housing 210, and supports a removable power source that energizes the motor 270, or the operation unit as a whole by providing electrical energy required for the operation unit to operate.

Referring initially to FIGS. 2 and 3, the first example embodiment is a power tool 200 e.g. a power file 200, with an elongate tool housing 210, a work tip 250 and a power source interface 240. The tool housing 210 defines a longitudinal axis that is parallel with the length of the elongate tool housing 210. The work tip 250 is located at a first end of the tool housing 210, or a first housing end, and supports a work member 260. As illustrated in FIGS. 2 and 3, the work tip 250 can be located at the forward end of the tool housing 210. The work member 260 may, for example, be a filer or a sander. The power source interface 240 is located at a second end of the tool housing 210, for example near the rearward or distal end of the tool housing 210, and supports a removable power source that energizes the motor 270, or the operation unit as a whole by providing electrical energy required for the operation unit to operate.

Referring initially to FIGS. 2 and 3, the first example embodiment is a power tool 200 e.g. a power file 200, with an elongate tool housing 210, a work tip 250 and a power source interface 240. The tool housing 210 defines a longitudinal axis that is parallel with the length of the elongate tool housing 210. The work tip 250 is located at a first end of the tool housing 210, or a first housing end, and supports a work member 260. As illustrated in FIGS. 2 and 3, the work tip 250 can be located at the forward end of the tool housing 210. The work member 260 may, for example, be a filer or a sander. The power source interface 240 is located at a second end of the tool housing 210, for example near the rearward or distal end of the tool housing 210, and supports a removable power source that energizes the motor 270, or the operation unit as a whole by providing electrical energy required for the operation unit to operate.

The tool housing 210 in FIGS. 2-3 include an elongate handle-shaped grip region 230, between the work tip 250 and the power source interface 240, to be gripped by a user of the power tool 200. The tool housing 210 also includes a drive region 220 that substantially encloses a motor 270 therein. The motor 270 is encased within the drive region 220, separate from the grip region 230, where the motor 270 is located between the grip region 230 and the work tip 250. The placement of the motor 270 in the drive region 220 separately from the grip region 230 provides an advantage of allowing the grip region to be slimmer and more easily held by a user of the power tool 200.

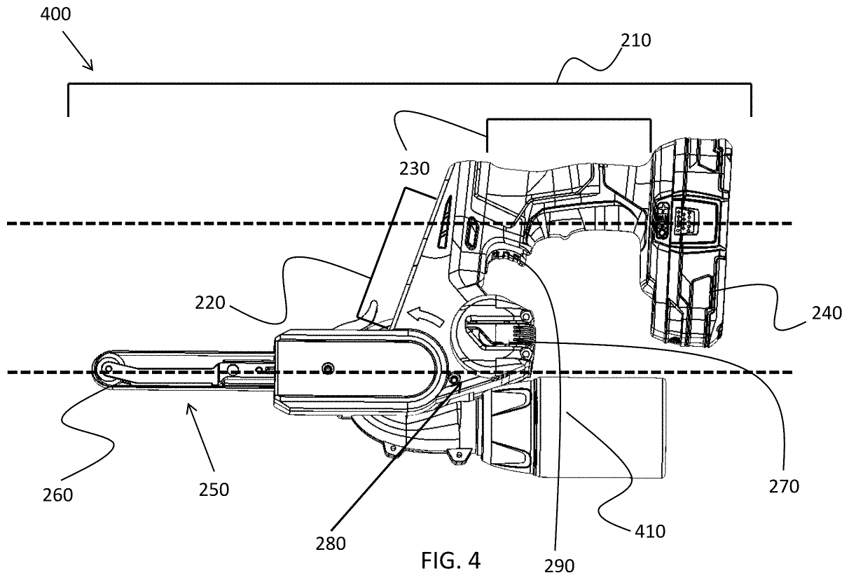

FIG. 4 shows an alternative example embodiment of a power tool 400 comprising a tool housing 210, a work tip 250, and a power source interface 240 as described above. In this example, the drive region 220 is perpendicular to the longitudinal axes (shown as dotted lines) of the work tip 250 and the grip region 230. However, even though the drive region 220 is arranged in a different location to the other example embodiments as shown in FIGS. 2 and 3, the handle-shaped grip region 230 and the work tip 250 are generally parallel to a longitudinal axis although on different horizontal planes. The grip region 230 in this embodiment functions almost exactly the same as the grip region 230 in the other embodiments described and therefore the operation of the power tool 200, 400 is not noticeably changed.

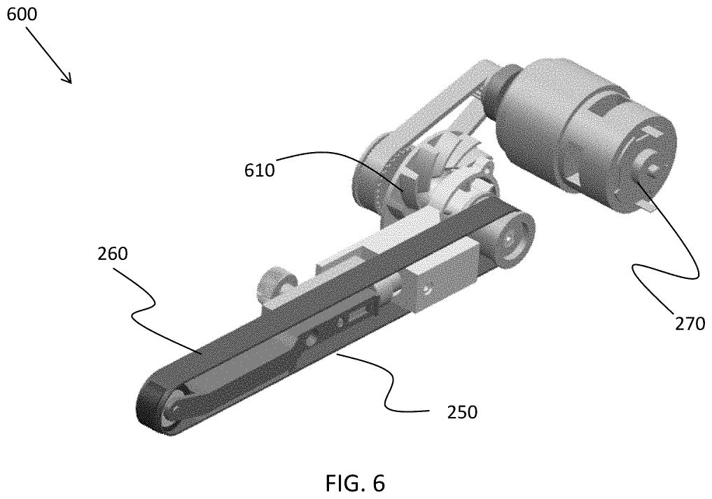

The example embodiment a shown in FIG. 4 includes a dust extractor 410 adjacent to the motor 270. The dust extractor 410 controls or minimizes the user's exposure to dust by extracting and capturing any dust produced by the power tool 200, 400. This is illustrated in an example embodiment of components of the tool housing 210 in FIG. 6, 600, where the work tip 250 supports a work member 260, which in the example embodiment is a belt drive. Any dust or debris generated by the contact of the work member 260 with a workpiece is drawn into the drive region 220 by a dust extraction fan 610 and collects in the dust extractor 410.

In accordance with the example embodiments in FIGS. 2-4, the motor 270 has a motor shaft that is oriented substantially perpendicular to the longitudinal axis of the tool housing 210 as shown in FIG. 3. This orientation of the motor 270 allows the power tool 200 to be shorter allowing for easier handling by a user. The motor 270 may be a brushless type or a brushed type motor.

As previously mentioned, the motor 270 is enclosed in the drive region 220 of the tool housing 210 in the embodiments as discussed. Accordingly, the drive region 220 has a firth girth or circumference that is configured to accommodate the motor 270. The grip region 230 has a second girth that is configured to conform to a user's grip. Preferably, the second girth is adapted to conform to an ergonomic profile of a user's hand. In a preferred embodiment, the second girth of the grip region 230 is smaller than the first girth of the drive region 220, thereby allowing optimal grip and handling of the power tool 200, 400.

The drive region 220 in the example embodiments shown in FIGS. 2-4 further encloses a transmission 280 that couples or connects the motor shaft's output to the work tip 250. Accordingly, in this embodiment the drive region 220 has a girth, i.e. a first girth, configured to substantially enclose the tool motor 270 and the transmission 280.

In a preferred embodiment, the handle-shaped grip region 230 is generally aligned along the longitudinal axis parallel with the length of the tool housing 210. Advantageously, as the grip region 230 does not have to accommodate the motor 270, the girth and shape of the grip region 230 is not constrained as in the prior art and can be adapted to be more user-friendly.

In the example embodiments shown in FIGS. 2-4, the grip region 230 is elongated for easy gripping. Preferably, the grip region 230 also has an ergonomic profile that conforms to the shape of a user's hand. In an example embodiment, the grip region 230 may have different sections of different radii in order to provide maximum grip when the grip region 230 is being held in different positions and orientations by the user.

The grip region or handle 230 may have a center portion covered with a layer of anti-slip material for enhancing the grip of the handle 230 by a user and preventing the power tool 200 from slipping out of the hand of the user, especially during long periods of use. Such a layer of anti-slip material can be a layer of soft rubber or a texturized surface.

In the example embodiments in FIGS. 2-4, the power tool 200, 400 further includes a trigger 290 located at an end of the handle-shaped grip region 230 and adjacent to the drive region 220. The trigger 290 is configured to activate the motor 270 and is operated by the index finger of a user's hand. For example, the trigger may be a pistol grip-type switch.

In a preferred embodiment, the power source interface 240 located at a second end of the housing 210 has battery engagement features for selectively engaging with a power tool battery (not shown) along an engagement direction that is perpendicular to the longitudinal axis.

In an alternative embodiment, the power source interface 240 located at a second end of the housing 210 has battery engagement features for selectively engaging with a power tool battery (not shown) along an engagement direction that is parallel to the longitudinal axis.

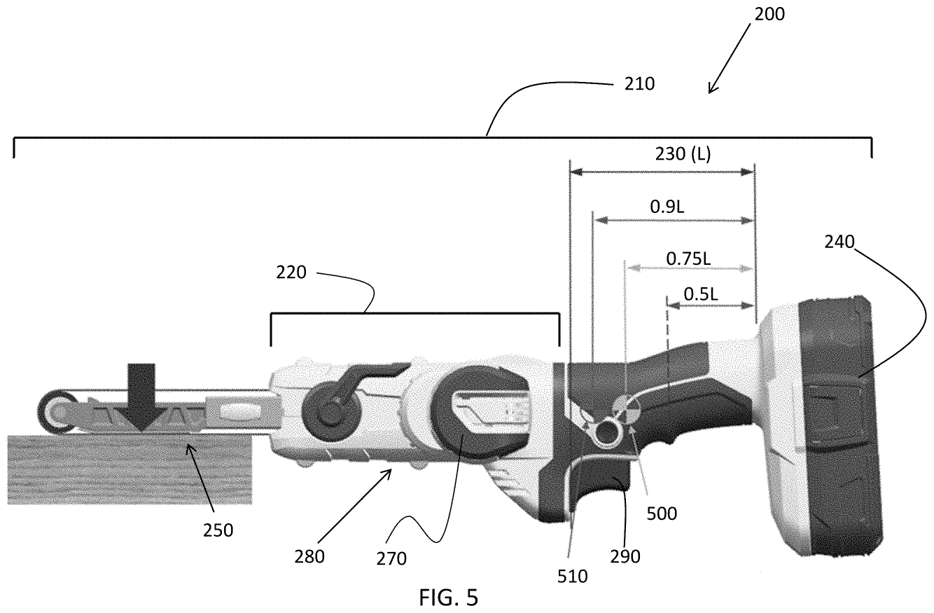

FIG. 5 is an exemplary embodiment of the power tool in FIGS. 2 and 3. Typically, the arrangement of a power source interface at a rearward or distal position of the tool housing and the arrangement of a motor in the grip region shifts the center of gravity of the power tool towards the rear-end of the power tool due to the weight of the power source interface, power tool battery, and motor. A user would therefore have to exert an additional tilting force to tilt the orientation of the power tool, or to apply extra force downwardly, to force tilting of the orientation of the power tool to maximize removal rate and offset loading of the power tool battery, as is the case in conventional power files or sanders in the prior art, as discussed previously in FIG. 1. As discussed in the previous example embodiments, the arrangement of the motor 270 in the drive region 220 separate to, and between, the grip region 230 and the work tip 250 shifts the center of gravity closer to the front or proximal end of the power tool 200. The motor 270 is located at a position on the tool housing 210 to provide a front-to-rear power tool center-of-gravity that is located at least partially proximate a front-end of the elongate handle-shaped grip region 230. This shift in the power tool center-of-gravity is illustrated by an exemplary embodiment in FIG. 5. The total length (L) of the grip region 230 is shown in FIG. 5. Conventional power tools, such as the exemplary embodiment 100 in FIG. 1, with a motor housed in the grip region 110 usually have a “rear-heavy” center-of-gravity that is located at a distance of around 0.5 L from the rear-end of the grip region 230. In comparison to conventional power tools, the power tool 200 of the present invention with one battery pack has a front-to-rear center-of-gravity 510 that is located at a distance of 0.9 L from the rear-end of the grip region 230, thereby providing a front-to-rear power tool center-of-gravity 510 located at least partially adjacent to a front-end of the grip region 230. In a further exemplary embodiment, the power tool of the present invention with two battery packs has a front-to-rear power tool center-of-gravity 500 that is located at a distance of around 0.75 L from the rear-end of the grip region 230, providing a front-to-rear power tool center-of-gravity 500 located at least partially adjacent to a front-end of the grip region 230. In accordance with an exemplary embodiment, the power source interface 240 may be located at the rear or second end of the tool housing 210 and proximate to a rear-end of the handle-shaped grip region 230.

The shift in the position of the front-to-rear power tool center-of-gravity nearer or adjacent to the front end of the handle-shaped grip region 230 exerts an increased downward force on the work tip 250, shown by the vertical arrow in FIG. 5. The increased downward force on the work tip 250 allows more aggressive sanding and an improved removal rate. Due to the novel placement of the motor 270 in the drive region 220 separate to the grip region 230, the weight distribution of the power tool 200 is optimized to direct the power tool to an optimized direction when the power tool 200 is naturally or ergonomically held by a user. Users will accordingly only have to exert a minimal force to hold and tilt the power tool.

In a further exemplary embodiment, the power tool is a power file or a drum sander, preferably is a handheld power file. In a preferred embodiment, the power tool is a power file having an elongate finger-shaped sanding member arranged generally parallel to the longitudinal axis.

The present invention is also directed to a tool housing for a power tool as described in the example embodiments above. Example embodiments also provide a housing for a power tool that includes an elongate drive region defining a longitudinal axis and an elongate handle-shaped grip region coupled with the drive region and parallel to the longitudinal axis. The drive region has a first girth and is configured to substantially enclose a tool motor and transmission. The grip region has a second girth and is configured to conform to an ergonomic grip profile of a user's hand. The second girth is smaller than the first girth, thereby providing the power tool with a slimmer grip region that increases user comfort and control as the grip region is more easily and conveniently graspable.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be understood that, if any prior art publication is referred to herein, such reference does not constitute an admission that the publication forms a part of the common general knowledge in the art.

1. A power tool, comprising:
a generally elongate tool housing defining a longitudinal axis parallel with the length of the elongate tool housing;
a work tip located at a first end of the tool housing for supporting a work member; and
a power source interface located at a second end of the tool housing for supporting a removable power source,
wherein the tool housing includes
an elongate handle-shaped grip region between the work tip and power source interface, and generally parallel to the longitudinal axis, and
a drive region that substantially encloses a motor separately from the handle-shaped grip region, and wherein the motor is located between the handle-shaped grip region and the work tip.

2. The power tool of claim 1, wherein the motor has a motor shaft oriented generally perpendicular to the longitudinal axis.

3. The power tool of claim 2, wherein the drive region further encloses a transmission coupling an output of the motor shaft to the work tip.

4. The power tool of claim 1, wherein the drive region of the tool housing has a first girth configured to accommodate the motor, and wherein the handle-shaped grip region has a second girth that is smaller than the first girth.

5. The power tool of claim 1, wherein the elongate handle-shaped grip region is generally aligned along the longitudinal axis.

6. The power tool of claim 1, wherein the elongate handle-shaped grip region has a profile that conforms to an ergonomic grip profile of a user's hand.

7. The power tool of claim 1, further including a trigger configured to activate the motor, the trigger located at an end of the elongate handle-shaped grip region and adjacent to the drive region.

8. The power tool of claim 1, wherein the power source interface further comprises battery engagement features for selectively engaging with a power tool battery along an engagement direction, wherein the engagement direction is perpendicular to the longitudinal axis.

9. The power tool of claim 1, wherein the power source interface further comprises battery engagement features for selectively engaging with a power tool battery along an engagement direction parallel to the longitudinal axis.

10. The power tool of claim 1, wherein the power tool is a power-file having an elongate finger-shaped sanding member arranged generally parallel to the longitudinal axis.

11. A housing for a power tool, the housing comprising:
an elongate drive region defining a longitudinal axis, the drive region having a first girth configured to substantially enclose a tool motor and transmission; and
an elongate handle-shaped grip region generally coupled with the drive region and parallel to the longitudinal axis, the grip region having a second girth configured to conform to an ergonomic grip profile of a user's hand, wherein the second girth is smaller than the first girth.

12. The housing of claim 11, wherein the elongate drive region has a work tool interface at a first housing end opposite an end coupled with the grip region, and wherein the grip region has a power source interface located at a second housing end opposite an end coupled with the drive region.

13. The housing of claim 11, wherein the tool motor has a motor shaft oriented generally perpendicular to the longitudinal axis.

14. The housing of claim 11, further including a trigger configured to activate the tool motor, the trigger located at an end of the grip region and adjacent to the drive region.

15. The housing of claim 12, wherein the power source interface has battery engagement features for selectively engaging with a power tool battery along an engagement direction, wherein the engagement direction is perpendicular to the longitudinal axis.

16. The housing of claim 11, wherein the power tool is a power-file having an elongate finger-shaped sanding member arranged generally parallel to the longitudinal axis.

17. A power tool, comprising:
a generally elongate tool housing defining a longitudinal axis parallel with the length of the elongate tool housing;
a work tip located at a first end of the tool housing for supporting a work member; and
a power source interface located at a second end of the tool housing for supporting a removable power source,
wherein the tool housing includes
an elongate handle-shaped grip region between the work tip and power source interface, and generally parallel to the longitudinal axis, and
a drive region that substantially encloses a motor separately from the handle-shaped grip region, and wherein the motor is located between the handle-shaped grip region and the work tip,
wherein the motor is located at a position on the tool housing to provide a front-to-rear power tool center-of-gravity located at least partially proximate a front-end of the elongate handle-shaped grip region.

18. The power tool of claim 17, wherein the front-to-rear power tool center-of-gravity increases a downward force on the work tip.

19. The power tool of claim 17, wherein the power source interface is located proximate a rear-end of the elongate handle-shaped grip region.

20. The power tool of claim 17, wherein the motor has a motor shaft oriented generally perpendicular to the longitudinal axis.

21. The power tool of claim 17, wherein the elongate handle-shaped grip region is generally aligned along the longitudinal axis.

22. The power tool of claim 17, wherein the power tool is a power-file having an elongate finger-shaped sanding member arranged generally parallel to the longitudinal axis.
